(19) United States
(12) Patent Application Publication
(10) Pub. No.: US 2014/0315776 A1
(43) Pub. Date: Oct. 23, 2014

(54) Container for use in a washing process

(71) Applicants: Lucia Krubasik, Ludwigshafen (DE); Judith Preuschen, Ludwigshafen (DE); Natascha Wolf, Ludwigshafen (US)

(72) Inventors: Lucia Krubasik, Ludwigshafen (DE); Judith Preuschen, Ludwigshafen (DE); Natascha Wolf, Ludwigshafen (US)

(73) Assignee: RECKITT BENCKISER N.V., Hoofddorp (NE)

(21) Appl. No.: 13/983,023

(22) PCT Filed: Jan. 30, 2012
(86) PCT No.: PCT/GB2012/050182

§ 371 Date: Oct. 25, 2013

(30) Foreign Application Priority Data
Jan. 31, 2011 (GB) 1101620.1

(51) Int. Cl. C11D 17/00; B65D 65/46

(52) U.S. Cl. CPC C11D 17/0039; B65D 65/46
USPC 510/439; 206/524.7

(57) ABSTRACT

The present invention provides a deformable water soluble or water dispersible outer pouch containing a detergent composition, the detergent composition comprising at least one phase in solid form and at least one liquid phase with at least one solid phase predominantly surrounded by a liquid phase. The pouches exhibit good physical and chemical stability and can also provide for sequential release of its ingredients.

### TECHNICAL FIELD

The present invention relates to a water soluble or water dispersible outer pouch comprising a detergent composition, the detergent composition comprising at least one solid phase and at least one liquid phase. At least one solid phase in the detergent composition is predominantly surrounded by a liquid phase. A process for preparing such a water soluble or water dispersible pouch is also provided.

### BACKGROUND AND PRIOR ART

It is known in the art to provide detergent compositions in water soluble or water dispersible pouches for use as unit dose compositions in washing operations such as laundering or dishwashing. They allow for a portioned dose of detergent composition to be added to a laundry washing machine or a dishwasher without the need for the consumer to handle the detergent compositions and without needing to measure a dose of detergent. This also reduces the risk of the consumer over-dosing or under-dosing the detergent. Also they are generally suitable for fitting into a wide range of different machine dispensing draws because they are deformable.

It is also known for such pouches to contain two or more compositions of different physical forms; one composition may for example be in powder form and one composition may be in a liquid form. The two phases are often separated into different compartments to keep the two phases apart.

Examples of such pouches are disclosed in for example WO 02/042400 and WO 2008/087424.

When the pouches contain a solid detergent composition, such as a shaped body, there is a significant risk that the pouch may be damaged by external physical stresses which can act upon it during storage or transit. For example the pouches may be deformed during these conditions and become damaged by the solid detergent composition inside leading to a loss in physical strength/stability of the pouch. This may lead to a weakened pouch which may then rupture before it is intended to be used.

Also when a solid detergent composition in the form of a shaped body is held within a pouch the aforementioned physical stresses can lead to fracture, weakening or breakage of the tablet. This is also undesirable as it is unattractive to the consumer and may lead to reduced performance of the detergent product.

Furthermore, many attempts have been made to develop detergent compositions which provide sequential release of ingredients or compositions. Sequential release can be desirable where, for example, one composition is to be delivered into the main wash and another composition is to be delivered into a pre-wash cycle or a rinse cycle of a washing operation. Sequential release detergent compositions are known for example from WO 2008/000567 which discloses two PVOH pouches attached to each other to enable the sequential release of two different detergent compositions. However it can be difficult to provide such products which also provide the desired levels of physical/chemical stability.

A further problem which can occur with detergent compositions in water soluble or water dispersible pouches is that when ingredients which can release gas upon storage are used in the detergent compositions this may lead to the pouches expanding with time. This can occur when e.g. bleaching compounds such as percarbonates, pthaloimidoperhexanioc acid (commonly referred to as PAP) and persulphates are included as they can release oxygen upon storage and the pouch material generally does not provide for the egress from the pouch of such gases. Ultimately this may lead to chemical instability of the detergent composition and/or physical instability of the pouch which can lead to rupture of the pouches. Furthermore, the expanded pouch may no longer easily fit into many different dispensing draws of a washing machine, such as in a dishwashing machine.

An object of the present invention is to address one or more of the problems outlined above.

### STATEMENT OF INVENTION

It has surprisingly been found that one or more of the above mentioned problems are addressed by the present invention. In particular it has been found that physically and chemically stable detergent composition containing pouches are provided. These pouches exhibit good stability on storage and transport. Furthermore sequential release of the detergent compositions is possible.

Thus according to a first aspect the present invention provides, a flexible water soluble or water dispersible outer pouch containing a detergent composition, the detergent composition comprising at least one phase in solid form and at least one liquid phase and wherein at least one solid phase is predominantly surrounded by a liquid phase.

It is preferred that at least one phase in solid form is a detergent tablet and further that the solid body itself has a water soluble or water dispersible covering or pouch.

It is also preferred that the volume ratio of the total solid phases to the total liquid phases in the outer pouch is in the range of from 10:1 to 1:5.

Preferably the at least one phase in solid form surrounded by the liquid phase so that is it suspended in the liquid phase.

Preferably the liquid phase comprises a surfactant and/or a polymer and the the surfactant preferably comprises at least one of cationic, anionic and/or nonionic surfactant. For the nonionic surfactant a C12-15-(6-10)-EO-(3-5)PO surfactant is most preferred.

Preferably the pouch comprises an alkylene oxide co-polymer, most preferably it comprises a random, branched ethylene oxide/propylene oxide copolymer having a molar ratio of EO:PO units in the range of from 10:1 to 1:1.

In one embodiment of the invention the pouch has a vent extending from the interior of the pouch to the outside of the pouch.

The present invention also provides, according to a second aspect, a method of washing items to be cleaned, the method comprising the step of contacting the water soluble or water dispersible pouch of the first aspect of the invention with water in the presence of items to be cleaned.

We have discovered that the pouches of the present invention allow for the detrimental effects of physical stresses which can act upon the pouches (e.g. during transport and/or storage) to be reduced or even eliminated. This has been found to provide pouches which exhibit good physical and chemical stability.

Without wishing to be bound by theory it is believed that the liquid phase or layer which predominantly surrounds the solid phase acts as a ‘shock-absorbing’ layer for the solid and so helps to reduce damage to the solid phase and/or damage to, or rupture of, the pouch and also to any inner pouch surrounding the solid.

The embodiment of the present invention wherein the pouch comprises the claimed venting system has been found to further improve the stability of the pouches when ingredients which have a tendency to release gas upon storage are included in the detergent compositions.

It has also been found that the invention provides effective and easily produced sequential release detergent compositions which also exhibit good stability.

By the term ‘water soluble or water dispersible pouch’ as used herein is meant a pouch which at least partially dissolves in water or disperses in 1 litre of water at 20° C. within 10 minutes either with agitation or without agitation to allow for egress of the contents of the package into the surrounding water.

By the term ‘liquid composition’ as used herein is meant a free-flowing mass having a continuous phase. It includes liquids, gels and pastes. For the avoidance of doubt it does not include solid bodies, granules or powders.

By the term ‘flexible’ as used herein is meant an outer pouch which can be deformed by hand by a typical consumer in at least one direction when the pouch is fully formulated to contain the at least one liquid phase and at least one solid phase.

Unless stated otherwise, all amounts herein are given as the percentage by weight of active ingredient based upon the weight of the total composition or the total particle as the context requires.

By the term ‘higher alkoxylate’ it is meant the alkoxylate group having the greatest number of carbon atoms in that alkoxylate group. By the term ‘lower alkoxylate’ it is meant the alkoxylate group having the lowest number of carbon atoms in that alkoxylate group. Thus for a mixed alkoxylate fatty alcohol comprising ethoxylate (EO) and propoxylate (PO) groups the EO is the lower alkoxylate and the PO is the higher alkoxylate.

By the term ‘liquid surfactant’ as used herein is meant a surfactant which is liquid at 20° C.

### DETAILED DESCRIPTION

The present invention will now be described in further detail.

### a) Flexible Water Soluble or Water Dispersible Outer Pouch

The flexible water soluble or water dispersible outer pouch may be formed from any suitable water soluble or water dispersible material. Preferably the material comprises a polymeric material.

The pouch may be of any suitable shape including spherical, ovoid, cylindrical, pyramidal, and rectangular, cuboid and square.

It is preferably formed from a film material which may either be a single layer film, or, a laminated film for example as disclosed in GB-A-2,244,258. The laminated film may be unoriented, monoaxially oriented or biaxially oriented. If the layers in the laminate film are oriented, they usually have the same orientation, although their planes of orientation may be different if desired. The layers in a laminate may be of the same or different composition. Thus they may each comprise the same polymer or a different polymer.

The thickness of the film used to produce the outer pouch may be up to 2 mm, more preferably up to 1 mm, more preferably 20 to 300 μm, more preferably 25 to 200 μm, especially 30 to 160 μm, more especially 35 to 150 μm and most especially 40 to 150 μm. The film thickness is chosen in combination with the type of material used so that the outer pouch remains deformable.

The film used to produce the outer pouch may itself be produced by any suitable process, for example by extrusion and blowing or by casting.

Examples of water-soluble polymers which may be used in a single layer film or in one or more layers of a laminate or which may be used for injection moulding or blow moulding are poly(vinyl alcohol) (PVOH), cellulose derivatives such as hydroxypropyl methyl cellulose (HPMC) and gelatin. The PVOH may be an ethoxylated PVOH. PVOH and HPMC are especially preferred according to the present invention. The PVOH may be partially or fully alcoholised or hydrolysed. For example it may be from 40 to 100%, preferably from 70 to 92%, more preferably about 88% or about 92%, alcoholised or hydrolysed. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water.

The outer deformable pouch may be formed by any suitable method which can be used to produce a deformable pouch. Such processes are known in the art and include vacuum forming, thermoforming and FFS (form fill seal processes including vertical form fill seal processes).

For example, in a thermoforming process the film may be drawn down or blown down into a mould. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. One skilled in the art can choose an appropriate temperature, pressure or vacuum and dwell time to achieve an appropriate package. The amount of vacuum or pressure and the thermoforming temperature used depend on the thickness and porosity of the film and on the polymer or mixture of polymers being used. Thermoforming of PVOH films is known and described in, for example, WO 00/55045. A suitable forming temperature for PVOH or ethoxylated PVOH is, for example, from 90 to 130° C., especially 90 to 120° C. A suitable forming pressure is, for example, 69 to 138 kPa (10 to 20 p.s.i.), especially 83 to 117 kPa (12 to 17 p.s.i.).

Vacuum forming processes are well known in the art and do not need further detailed description here, such processes can be used alone or in combination with thermo-forming. In brief, typically a vacuum is used to draw the pouch material into a mould prior to the formed pouch being filled with detergent product. A suitable forming vacuum is 0 to 4 kPa (0 to 40 mbar), especially 0 to 2 kPa (0 to 20 mbar). A suitable dwell time is, for example, 0.4 to 2.5 seconds, especially 2 to 2.5 seconds.

While desirably conditions chosen within the above ranges, it is possible to use one or more of these parameters outside the above ranges, although it may be necessary to compensate by changing the values of the other two parameters.

Alternatively the outer pouch may be produced by a Form Fill Seal process as well known in the art and especially a Vertical Form Fill Seal process. Such processes are well known in the art and do not need further detailed description here.

Generally the outer pouch has a volume in the range of from 5 to 50 ml, preferably from 10 to 40 ml, such as 15 to 30 ml. It will be appreciated that the size may vary in accordance with the intended use of the pouch. If the pouch contains a detergent additive product it will tend to have a volume in the range below 40 ml whereas if the pouch contains a “complete” detergent it will tend to have a volume which is above 10 ml.

In one preferred embodiment the outer pouch comprises a venting system which comprises a channel from the interior of the external pouch to the atmosphere. This channel serves as a conduit for the build up of any gases within the pouch and allows them to vent to the atmosphere thus reducing or avoiding the undesirable expansion of the pouches. The venting system is preferably a channel which passes though the outer wall of the pouch. The venting system may be formed in any suitable way. Preferably it is a channel which passes from the interior of the pouch to the outside and is formed by a part of the external pouch wall not being joined together thus leaving an open channel through the pouch wall.

The venting system may be produced by filling an outer flexible pouch with the liquid phase of the invention and sealing that pouch. Preferably this sealed outer pouch has a substantially flat appearance. The outer sealed pouch is then folded around the solid detergent phase which is preferably a detergent tablet and sealed on all sides except for in one small area which then serves as a vent between the internal solid detergent phase and the outside of the pouch. Decomposition gases from the tablet are then able to escape to the atmosphere. The vent on the outer surface of the outer pouch will typically will have a total surface area of at most 100 mm², preferably at most 50 mm², mm such as at most 25 mm².

### b) The Detergent Composition Liquid Phase.

The detergent composition comprises one or more liquid phases inside the outer pouch. In one embodiment of the invention two or more liquid phases are present.

The liquid phase of the detergent composition is preferably at least partially in contact with the outer pouch, more preferably it is in contact with at least 80% of the inner surface area of the outer pouch, even more preferably in contact with at least 90% of the inner surface area and most preferably with 100% of the inner surface area. By the inner surface area of the outer pouch is meant the surface area of the inwardly facing surface of the pouch. Typically according to the present invention this phase is positioned so that it is in contact with the outer pouch and it forms a barrier between the outer pouch and the solid phase if the detergent composition.

The liquid phase is free flowing; that is it is not a rigid gel. It is preferred that the liquid phase has a viscosity in the range of from 1 to 100,000 mPas at 20° C., more preferably from 50 to 75,000, such as 75 to 50,000. By controlling the viscosity of this phase it is possible to control the movement of the tablet within the pouch; ideally the tablet should not be able to move around the internal volume of the outer pouch in an unrestricted manner as this can reduce the protective effect of the surrounding liquid phase upon the solid phase.

It is preferred that the liquid phase has a specific density which is closely matched to that of the solid phase in such a manner so as to allow the solid phase to be held in a substantially suspended manner within the pouch for the reasons given in the preceding paragraph. Preferably the liquid phase has a specific density in the range of from 0.9 to 1.5 at 20° C., more preferably 1 to 1.4, most preferably 1.1 to 1.35.

In one embodiment of the invention it is preferred that the liquid phase is transparent or translucent so that the solid phase can easily be seen by the naked eye through the former inside the pouch. If this phase contains suspended ingredients in addition to the detergent phase in solid form (for example enzyme speckles or bleach/bleach activator particles then it is preferred that the phase is transparent or translucent so that these suspended particles are visible to the consumer). In another embodiment the liquid phase may be substantially opaque e.g. by the addition of pearlising agents.

Generally the liquid phase of the detergent composition is present in the pouch in an amount of from 0.25 ml to 10 ml, preferably from 1 to 7.5 ml, such as 2 to 5 ml. It will be appreciated that the amount of this phase present in the pouch may vary in accordance with the intended use thereof. If the pouch contains a detergent additive product it will tend to be present in an amount below 2 ml whereas if the pouch contains a “complete” detergent it will tend to be present in an amount in the range of from 2 to 5 ml.

The liquid phase may be of any suitable formulation which is compatible with the material used to produce the pouch. In one embodiment of the invention this phase may be an aqueous based formulation which comprises from 15 to 70% wt total water (based on the weight of this phase). In another embodiment of the present invention this phase may be a substantially anhydrous composition comprising less than 15% wt total water (based on the weight of this phase), most preferably less than 5% wt total water, even more preferably less than 2% wt total water. It has been found that when a substantially anhydrous liquid phase is used the solid phase may not then need to be held within an inner water soluble or water dispersible pouch or coating as it does not dissolve to any significant extent in the anhydrous liquid phase. This has the advantage of further reducing the cost of producing the pouches and removes at least one process step in the manufacture. Ideally the liquid phase will have a viscosity higher than that of water.

The liquid phase in one embodiment preferably comprises a surfactant. For laundry applications the surfactant is preferably a cationic, anionic and/or non-ionic surfactant (although cationic and anionic would not be formulated together in the same phase) and for dishwashing applications the surfactant is preferably a non-ionic surfactant.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates.

Generally, the alkyl or acyl radical in these various compounds comprise a carbon chain containing 12 to 20 carbon atoms.

Non-ionic surfactants are preferred for automatic dishwashing and some other hard surface cleaning operations as they are considered to be low foaming surfactants.

Suitable nonionic surfactants include alkoxylated non-ionic surfactants prepared by the reaction of a monohydroxy alkanol or alkylphenol with 6 to 20 carbon atoms. Preferably the surfactants have at least 8 moles particularly preferred at least 10 moles, and still more preferred 12 or more moles of alkylene oxide per mole of alcohol or alkylphenol. Preferred non-ionic surfactants are the non-ionics from a linear chain fatty alcohol with 10-18 carbon atoms and at least 8 moles, particularly preferred at least 10 and still more preferred at least 12 moles, of alkylene oxide per mole of alcohol. It is preferred that the nonionic surfactants comprise ethylene oxide in the alkylene oxide groups According to a preferred one embodiment of the invention, the non-ionic surfactants additionally may comprise propylene oxide units in the molecule in addition to ethylene oxide units.

The standard non-ionic surfactant structure is based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO). Surfactants may also comprise butylene oxide units (BO) as a result of butoxylation of the fatty alcohol. Preferably, this will be a mix with PO and EO units. The surfactant chain can be terminated with a butyl (Bu) moiety.

The length of the fatty alcohol and the degree of ethoxylation/propoxylation determines if the surfactant structure has a melting point below room temperature or in other words if is a liquid or a solid at room temperature. It is especially preferred that the nonionic surfactant used according to the invention is liquid or substantially liquid at room temperature (20° C.).

It is especially preferred that the mixed alkoxylate fatty alcohol nonionic surfactant comprises at least two EO, PO or BO groups and especially a mixture of EO and PO groups, preferably EO and PO groups only. It is most preferred that the mole ratio of the lower alkoxylate group to the higher alkoxylate group is at least 1.1:1, more preferably at least 1.5:1, and most preferably at least 1.8:1, such as at least 2:1 or even at least 3:1.

It is especially preferred that when a non-ionic surfactant is used in the liquid phase it comprises a liquid mixed alkoxylate fatty alcohol non-ionic surfactant comprising a greater number of moles of the lower alkoxylate group than of the higher alkoxylate group in the molecule, especially a greater number of EO groups than of PO groups.

The mixed alkoxylate fatty alcohol non-ionic surfactants used in the compositions of the invention may be prepared by the reaction of suitable monohydroxy alkanols or alkylphenols with 6 to 20 carbon atoms. Preferably the surfactants have at least 8 moles, particularly preferred at least 10 moles of alkylene oxide per mole of alcohol or alkylphenol. Particularly preferred liquid mixed alkoxylate fatty alcohol non-ionic surfactants are those from a linear chain fatty alcohol with 12-18 carbon atoms, preferably 12 to 15 carbon atoms and at least 10 moles, particularly preferred at least 12 moles of alkylene oxide per mole of alcohol.

An especially preferred mixed alkoxylate fatty alcohol nonionic surfactant according to the present invention comprises a C10-C18 Carbon chain, especially a C12-C16 carbon chain, between 3 to 5 moles of the higher alkoxylate group and between 6 to 10 moles the lower alkoxylate group. Especially preferred are mixed alkoxylate fatty alcohol nonionic surfactants having 4 or 5 moles of the higher alkoxylate group and 7 or 8 moles of the lower alkoxylate group. According to one aspect of the invention a mixed alkoxylate fatty alcohol nonionic surfactant having 4 or 5 PO moles and 7 or 8 EO moles is especially preferred, especially 4 PO moles and 8 EO moles. In an especially preferred embodiment the mixed alkoxylate fatty alcohol nonionic surfactant comprises a C10-C18 EO/PO surfactant, in particular a C12-15 EO/PO and most preferably a C12-15-(6-10)-EO-(3-5)PO surfactant such as a C12-15 8EO/4PO.

Surfactants of the above type which are ethoxylated mono-hydroxy alkanols or alkylphenols which additionally comprise poly-oxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant. P When PO units are used they preferably constitute up to 25% by weight, preferably up to 20% by weight and still more preferably up to 15% by weight of the overall molecular weight of the non-ionic surfactant.

Suitable liquid mixed alkoxylate fatty alcohol non-ionic surfactants can be found in the class of reverse block copolymers of polyoxyethylene and poly-oxypropylene and block copolymers of polyoxyethylene and polyoxypropylene initiated with trimethylolpropane.

Suitable types can also be described by the formula:

R₁O[CH₂CH(CH₃)O]ₓ[CH₂CH₂O]_{y}[CH₂CH(OH)R₂]

where R1 represents a linear or branched chain aliphatic hydrocarbon group with 4-18 carbon atoms or mixtures thereof, R2 represents a linear or branched chain aliphatic hydrocarbon rest with 2-26 carbon atoms or mixtures thereof, x is a value between 0.5 and 1.5 and y is a value of at least 15.

Another group of suitable liquid mixed alkoxylate fatty alcohol non-ionic surfactants can be found in the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5 with the proviso that the molecule contains more of the lower alkoxylate than of the higher alkoxylate. When the value of x is >2 each R₃ in the formula above can be different. R₁ and R₂ are preferably linear or branched chain, saturated or unsaturated, aliphatic or aromatic hydrocarbon groups with 6-22 carbon atoms, where group with 8 to 18 carbon atoms are particularly preferred. For the group R₃=H, methyl or ethyl are particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃=H) or propylene oxide (R₃=methyl) units which can be used in every single order for instance (PO)(EO)(EO), (EO)(PO)(EO), (EO)(EO)(PO), (PO) (EO) (PO) and (PO)(PO)(EO). Only the mixed alkoxylates having comprising more of the lower alkoxylate than of the higher alkoxylate are suitable as the claimed mixed alkoxylate fatty alcohol nonionic surfactant. The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

Other suitable surfactants are disclosed in WO 95/01416, to the contents of which express reference is hereby made.

In a preferred embodiment of the present invention the mixed alkoxylate fatty alcohol non-ionic surfactants have the general formula;

R₁-[EO]ₙ-[PO]ₘ—[BO]ₚ-Bu_{q}

wherein:
R₁ is an alkyl group of between C₈ and C₂₀;
EO is ethylene oxide;
PO is propylene oxide;
BO is butylene oxide;
Bu is butylene
n and m are integers from 1 to 15;
p is an integer from 0 to 15; and
q is 0 or 1.

Examples of especially preferred mixed alkoxylate fatty alcohol non-ionic surfactants can be found in the Plurafac™, Lutensol™ and Pluronic™ ranges from BASF and the Genapol™ series from Clariant.

Other suitable surfactants are disclosed in WO 95/01416, to the contents of which express reference is hereby made.

The use of mixtures of any of the above nonionic surfactants is suitable in the context of the present invention.

Typically the liquid phase will comprise anionic or nonionic surfactant, when it is present, in an amount of from 10-100% wt based on the weight of this phase, preferably 50-100% wt. such as 75-95% wt.

Cationic surfactants which can be used in the compositions of the present invention, especially where a fabric conditioning effect is desired in a laundry application, contain amino or quaternary ammonium hydrophilic moieties which are positively charged when dissolved in water. Cationic surfactants among those useful herein are disclosed in the following documents, all incorporated by reference herein: M.C. Publishing Co., McCutcheon's Detergents and Emulsifiers, (North American edition 1979); Schwartz, et al., Surface Active Agents, Their Chemistry and Technology, New York: Interscience Publishers, 1949; U.S. Pat. No. 3,155,591, Hilfer, issued Nov. 3, 1964; U.S. Pat. No. 3,929,678, Laughlin, et al., issued Dec. 30, 1975; U.S. Pat. No. 3,959,461, Bailey, et al., issued May 25, 1976; and U.S. Pat. No. 4,387,090, Bolich, Jr., issued Jun. 7, 1983.

Among the quaternary ammonium-containing cationic surfactant materials useful herein are those of the general formula:

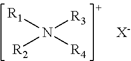

wherein R1-R4 are independently an aliphatic group of from about 1 to about 22 carbon atoms, or an aromatic, alkoxy, polyoxyalkylene, alkylamido, hydroxyalkyl, aryl or alkylaryl group having from about 12 to about 22 carbon atoms; and X is an anion selected from halogen, acetate, phosphate, nitrate and alkyl sulfate radicals. The aliphatic groups may contain, in addition to carbon and hydrogen atoms, ether linkages, and other groups such as amino groups.

Other quaternary ammonium salts useful herein have the formula:

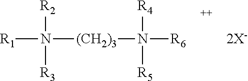

wherein R1 is an aliphatic group having from about 16 to about 22 carbon atoms, R2, R3, R4, R5, and R6 are selected from hydrogen and alkyl having from about 1 to about 4 carbon atoms, and X is an ion selected from halogen, acetate, phosphate, nitrate and alkyl sulfate radicals. Such quaternary ammonium salts include tallow propane diammonium dichloride. Preferred quaternary ammonium salts include dialkyldimethylammonium chlorides, wherein the alkyl groups have from about 12 to about 22 carbon atoms and are derived from long-chain fatty acids, such as hydrogenated tallow fatty acid (tallow fatty acids yield quaternary compounds wherein R1 and R2 have predominately from 16 to 18 carbon atoms). Examples of quaternary ammonium salts useful in the present invention include ditallowdimethyl ammonium chloride, ditallowdimethyl ammonium methyl sulfate, dihexadecyl dimethyl ammonium chloride, di(hydrogenated tallow)dimethyl ammonium chloride, dioctadecyl dimethyl ammonium chloride, dieicosyl dimethyl ammonium chloride, didocosyl dimethyl ammonium chloride, di(hydrogenated tallow)dimethyl ammonium acetate, dihexadecyl dimethyl ammonium chloride, dihexadecyl dimethyl ammonium acetate, ditallow dipropyl ammonium phosphate, ditallow dimethyl ammonium nitrate, di(coconutalkyl)dimethyl ammonium chloride, and stearyl dimethyl benzyl ammonium chloride. Ditallow dimethyl ammonium chloride, dicetyl dimethyl ammonium chloride, stearyl dimethyl benzyl ammonium chloride and cetyl trimethyl ammonium chloride are preferred quaternary ammonium salts useful herein. Di-(hydrogenated tallow)dimethyl ammonium chloride is a particularly preferred quaternary ammonium salt.

Salts of primary, secondary and tertiary fatty amines are also preferred cationic surfactant materials. The alkyl groups of such amines preferably have from about 12 to about 22 carbon atoms, and may be substituted or unsubstituted. Secondary and tertiary amines are preferred, tertiary amines are particularly preferred. Such amines, useful herein, include stearamido propyl dimethyl amine, diethyl amino ethyl stearamide, dimethyl stearamine, dimethyl soyamine, soyamine, myristyl amine, tridecyl amine, ethyl stearylamine, N-tallowpropane diamine, ethoxylated (5 moles E.O.) stearylamine, dihydroxy ethyl stearylamine, and arachidylbehenylamine. Suitable amine salts include the halogen, acetate, phosphate, nitrate, citrate, lactate and alkyl sulfate salts. Such salts include stearylamine hydrochloride, soyamine chloride, stearylamine formate, N-tallowpropane diamine dichloride and stearamidopropyl dimethylamine citrate. Cationic amine surfactants included among those useful in the present invention are disclosed in U.S. Pat. No. 4,275,055, Nachtigal, et al., issued Jun. 23, 1981, incorporated by reference herein.

If included in the compositions of the present invention, the cationic surfactant is preferably present at from 0.01% wt to percent to 10% wt, more preferably 0.1 to 5% wt such as 0.15 to 2% wt based on the weight of liquid phase.

Mixtures of anionic and nonionic surfactants, or, cationic and nonionic surfactants may also be used provided that such mixtures are stable.

The liquid phase may comprise one or more polymers, especially polymers not having a positive charge.

According to one embodiment of the present invention, it is preferred that the liquid phase comprises (statistical) copolymers of alkylene oxides. It especially preferred that the one or more polymer(s) comprise copolymers of ethylene oxide (EO) and propylene oxide (PO). Such polymers may be selected from the family of poly-glycols.

Especially preferred copolymers of alkylene oxides according to one embodiment of the invention are random, branched ethylene oxide/propylene oxide copolymers and especially those having a molecular weight of 500 to 50,000 g/mol, more preferably 2,000 to 40,000 g/mol and most preferably 4,000 to 30,000.

The structure of such copolymers is given below;

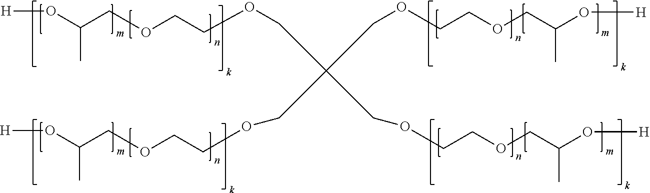

The ratio of EO units (n) to PO (m) is defined by the ratio n:m wherein N is in the range of from 1 to 100 and M is in the range of from 1 and 100. It is preferred that the ratio of n:m is in the range of from 50:1 to 1:50, more preferably in the range of from 20:1 to 1:10, such as of from 10:1 to 1:7, most especially 7:1 to 1:7. The value of K for each arm of the copolymer (k) may individually be in the range of from 1-5,000, more preferably in the range of from 10-2,500, most preferably of from 50-1,000.

Especially good results have been obtained with such alkylene oxide polymers having an n:m ratio in the range of from 10:1 to 1:1, and most especially in the range of from 6:1 to 1:1.

The viscosity of these polymers is typically in the range of from 75 to 50,000 mPas at 20° C., preferably 100 to 25,000.

The pH of the copolymers of alkylene oxides measured in 1 wt % water at 20° C. is in the range of from 5 to 12, most preferably in the range of from 6.5 to 7.5, for example 7. These copolymers are typically transparent liquids with a cloud point in the range of from 50° C. to 90° C.

These copolymers of alkylene oxides have a star-like shape and produce enhanced stability effects compared with standard solvents and surfactants. They are commercially available from Clariant, for example as Polyglykol P41/12000.

The polymer may be used as the liquid phase per se, that is, it may be used alone without additional ingredients therein. It may also be used in combination with other liquid ingredients in the liquid phase and/or in combination with minor amounts (typically less than 10% wt based on the weight of the liquid phase) of a dispersed solid phase (for example a bleach or bleach activator).

It is also possible for the liquid phase to comprise a combination of two or more of the above ingredients. Suitable examples of such mixtures include a mixture of an anionic and/or nonionic surfactant and a polymer of the aforementioned type, for example a combination of an anionic and/or nonionic surfactant and a copolymer of alkylene oxides as described above. In this case the weight ratio of the total amount of anionic/nonionic surfactant to the amount of polymer is preferably in the weight ratio of from 1:100 to 1:1, preferably 1:20 to 1:1, most preferably 1:10 to 1:1. The amount of the polymer present in the liquid phase is preferably in the range given below. The amount of surfactant can easily be calculated from the volume of the liquid phase and the ratio with the polymer. A mixture of a cationic surfactant and a polymer of the aforementioned type, for example a combination of a cationic surfactant and a copolymer of alkylene oxides as described above may also be used. In this case the weight ratio of the total amount of cationic surfactant to the amount of polymer is preferably as above for the anionic/nonionic surfactants. The amount of the polymer present in the liquid phase is preferably in the range given below. The amount of surfactant can easily be calculated from the volume of the liquid phase and the ratio with the polymer.

Typically the liquid phase will comprise the polymer in an amount of from 10-100% wt based on the weight of this phase, preferably 50-100% wt. such as 75-95% wt.

These polymers have been found to provide very good stability for the solid phase and the outer pouch. Indeed by using especially the EO:PO co-polymers having the m:n ratio above it has been found that it can be possible for the solid phase to be contained in a stable manner in the liquid phase without the need for the solid phase to itself have an outer coating or pouch. This has been found to be the case even when the solid phase comprises a bleach material. This provides the further advantage that the pouches of the present invention do then not typically require a venting system as described herein to allow for the escape of undesirable gases which may otherwise build up in the pouch during storage. There is also the additional advantage that these copolymers of alkylene oxides provide antifoam benefits so that conventional antifoams do not always need to be additionally added to the detergent formulation. Also as these polymers are transparent they provide the consumer with an attractive product where the solid phase can readily be viewed through the liquid phase.

Other optional ingredients may also be included in conventional amounts in the liquid phase. Examples include enzymes, bleach activators (e.g. TAED) or bleach catalysts as further described hereinbelow, bleaches (such as PAP or percarbonate or any of the bleaching agents described further hereinbelow), silver-corrosion inhibiting agents, enzyme stabilizers, antifoam, soil release agents, dye transfer inhibiting agents, brighteners, perfumes, colorants and dyes. However incompatible ingredients will preferably not be included together in this phase. Such optional ingredients may be present in liquid form or may be present in solid form e.g. as speckles.

The liquid phase of the detergent composition may be produced by any suitable means. Suitable methods are already well known in the art e.g. mixing the ingredients together until a homogenous solution is obtained.

### c) Optional Inner Pouch or Coating Around the Solid Phase of the Detergent Composition

The solid phase of the detergent composition in one embodiment of the invention has an external water soluble or water dispersible coating or pouch which provides a barrier between it and the liquid phase. This barrier helps to protect the solid phase from the liquid phase of the detergent composition and is useful where the two phases are incompatible e.g. because the solid dissolves with time in the liquid, phase because the two phases contain incompatible ingredients.

The solid phase may have either an external coating (that is a covering which is physically attached to it) or it may be placed inside a water soluble or water dispersible pouch (hereinafter referred to as an inner pouch) of a suitable size. In this case of the coating this conforms substantially to the external dimensions of the solid. The pouch may be of slightly larger dimensions than the solid inside it although ideally it fits as closely around the solid phase as possible.

The inner pouch/coating may be formed from any of the water soluble or water dispersible materials disclosed hereinabove for the outer pouch. The inner pouch/coating and outer pouch may be formed from the same or different materials. The inner pouch is preferably a deformable pouch. The thickness of the inner pouch is preferably up to 2 mm, more preferably up to 1 mm, more preferably 20 to 300 μm, more preferably 25 to 200 μm, especially 30 to 160 μm, more especially 35 to 150 μm and most especially 40 to 150 μm.

If the solid phase has a coating around it may have a coating having a thickness in the above stated range.

The inner pouch may be produced by any of the methods described above for the outer pouch. The coating may be applied to the solid body by any suitable means including spray coating and dipping.

It is preferred that the inner pouch surrounding the solid phase is not physically attached to the outer pouch e.g. it is in a pouch-in-pouch arrangement with the inner pouch held inside the outer pouch. If the solid phase is covered with a coating rather than a pouch then it is also preferred that the coated solid phase is not physically joined to the outer pouch. It is especially preferred that the coated solid phase/solid phase inside the inner pouch is surrounded by the liquid phase which in turn is surrounded by the outer pouch.

The volume of the inner pouch is preferably in the region of from 5-40 ml, preferably from 10 to 30 ml, more preferably 15 to 25 ml.

### d) the Detergent Composition Solid Phase

The detergent composition in solid phase preferably comprises a solid body and especially a detergent tablet which may be of any suitable shape. It is especially preferred that the solid body is in the shape of a spherical, ovoid, cylindrical, pyramidal, and rectangular, cuboid, square or a pill.

The solid body may be a single phase solid body or it may comprise two or more phases as desired. The formulations making up each phase of the solid body are preferably of different formulations. The multiple phases are preferably arranged in layers.

The solid phase may be produced by any suitable method known in the art. For example the solid body may be produced by compression of a powder to form a tablet or by casting or extrusion methods. Such processes are well known in the art and do not require further description here.

The volume of the solid phase is preferably in the region of from 5-40 ml, preferably from 10 to 30 ml, more preferably 15 to 25 ml.

In one embodiment of the present invention it is preferred that the volume ratio of the total solid phases to the total liquid phases in the range of from 10:1 to 1:5, more preferably 8:1 to 1:2, more preferably 6:1 to 1:1, such as 5:1 to 2:1.

The solid phase may comprise any ingredients used in detergent applications.

The solid phase may comprise the anionic, nonionic and/or cationic surfactants (provided that they are compatible in the same phase—thus anionic and cationic surfactants would not generally be used together) as given above for the liquid phase of the detergent compositions. The solid phase may also comprise the alkylene oxide co-polymers as given above for the liquid phase of the detergent compositions. The surfactants are typically present in the solid phase in an amount in the range of from 0.01 to 25% wt, such as 0.5 to 20% wt, e.g. 1 to 10% wt. The alkylene oxide co-polymers are typically present in an amount of from 0.05 to 10% wt in the solid phase, preferably 1 to 5% wt.

It is preferred that the solid phase comprises a bleaching compound. Any conventional bleaching compound can be used in conventional amounts. Most preferably the bleach is selected from inorganic peroxy-compounds and organic peracids and the salts derived therefrom.

Examples of inorganic perhydrates include persulfates such as peroxymonopersulfate (KMPS), perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life. The preferred percarbonate is sodium percarbonate of the formula 2Na₂CO₃.3H₂O₂. A percarbonate, when present, is preferably used in a coated form to increase its stability.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

The bleach is preferably present in an amount of 2-30% wt, more preferably 2-25% wt, most preferably 5-20% wt based on the total weight of the solid body.

The solid phase may also comprise one or more bleach activators or bleach catalysts depending upon the nature of the bleaching compound. Any suitable bleach activator may be included for example TAED. Any suitable bleach catalyst may be used for example manganese acetate or dinuclear manganese complexes such as those described in EP-A-1,741,774. Conventional amounts may be used.

A builder may also be included in the solid phase and it may be either a phosphorous-containing builder or a phosphorous-free builder as desired.

If phosphorous-containing builders are also to be used it is preferred that mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP). Conventional amounts of the phosphorous-containing builders may be used in the solid phase, typically being in the range of from 15 to 60% wt, such as 20 to 50% wt, for example 30 to 45% wt based on the weight of the solid phase.

If a phosphorous-free builder is included it is preferably chosen from amino acid based compounds and/or succinate based compounds. The terms ‘succinate based compound’ and ‘succinic acid based compound’ are used interchangeably herein. Conventional amounts of the amino acid based compound and/or succinate based compound may be used typically in the range of from 20% wt to 80% wt, such as 25 to 70% wt.

Preferred examples of amino acid based compounds which may be used are MGDA (methyl-glycine-diacetic acid, and salts and derivatives thereof) and GLDA (glutamic-N,N-diacetic acid and salts and derivatives thereof). Other suitable builders are described in U.S. Pat. No. 6,426,229 which are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

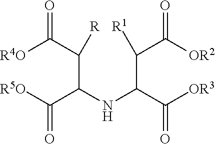

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

It is especially preferred according to the present invention that the builder comprises methyl-glycine-diacetic acid, glutamic-N,N-diacetic acid, tetrasodium imminosuccinate, or (hydroxy)iminodisuccinic acid and salts or derivatives thereof.

The phosphorous-free builder may also or alternatively comprise non-polymeric organic molecules with carboxylic group(s), examples include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferably the total amount of builder present in the solid phase is an amount of at least 20 wt %, and most preferably at least 25 wt %, preferably in an amount of up to 70 wt %, preferably up to 65 wt %, more preferably up to 60 wt %. The actual amount used in the compositions will depend upon the nature of the builder used. If desired a combination of phosphorous-containing and phosphorous-free builders may be used.

The solid body may optionally comprise a secondary builder (or cobuilder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

Preferably the total amount of co-builder present in the solid phase is an amount of up to 10 wt %, preferably at least 5 wt %. The actual amount used will depend upon the nature of the builder used.

The solid phase may also comprise a source of acidity or a source of alkalinity, to obtain the desired pH, on dissolution. A source of alkalinity may suitably be any suitable basic compound for example any salt of a strong base and a weak acid. When an alkaline composition is desired silicates are amongst the suitable sources of alkalinity. Preferred silicates are sodium silicates such as sodium disilicate, sodium metasilicate and crystalline phyllosilicates. Another source of alkalinity may be a carbonate or bicarbonate (such as the alkali metal or alkaline earth metal salts). A source of acidity may suitably be any suitable acidic compound for example a polycarboxylic acid. Conventional amounts of such ingredients may be used.

The solid phase may also comprise a polymer in conventional amounts, especially a sulphonated polymer and most especially a sulphonated polymer comprising monomers of a carboxylic acid or a salt thereof and a sulphonated monomer, especially acrylic acid and/or 2-acrylamido-2-methyl-1-propanesulphonic acid (AMPS). Commercially available examples of the preferred sulphonated polymer are available from Rohm & Haas under the trade names Acusol 587G and Acusol 588G.

Other optional ingredients may also be included in conventional amounts in the solid phase. Examples include enzymes, silver-corrosion inhibiting agents, enzyme stabilizers, antifoam, soil release agents, binders, dye transfer inhibiting agents, brighteners, perfumes, colorants and dyes. However incompatible ingredients will preferably not be included together in this phase. Organophosphoric acids are often used as corrosion inhibitors. Diphosphoric acids and their salts are preferred according to the present invention with the tetrasodium and disodium salts being especially preferred. 1, hydroxy, ethylidene 1,1-diphosphoric acid (HEDP) and it tetrasodium or disodium salts is especially preferred. The organophosphoric acid is preferably used in an amount of from 0.05 to 10% wt, such as 0.1 to 7.5% wt based on the weight of the phase of the detergent composition in which it is present.

A binder may be present in the solid phase of the detergent composition, usually at an amount of from 0.05 wt % to 15 wt %, more preferably from 1 wt % to 10 wt %.

Preferred examples of binders include; fatty acids and derivatives thereof, such as alkali metal and ammonium salts of fatty acid carboxylates (e.g. ammonium stearate, sodium oleate, potassium laureate, magnesium stearate), also polyethylene glycol (PEG)/glycerol functionalised with fatty acid carboxylates (e.g. PEG mono-oleate, PEG ricinoleate, glycerol mono-ricinoleate); sucrose glycerides; oils (such as olive oil, silicon oil, paraffin oil). Most preferably the binder comprises polyethylene glycol having a molecular weight of from 500 to 30000, more preferably of from 1000 to 5000 and most preferably of from 1200 to 2000. Preferred examples of polyethylene glycol include those having a molecular weight of 1500 or 3000. Grades of PEG are sold with reference to their nominal molecular weights, and when we talk, for example, about PEG of molecular weight 500 to 30000, we are talking about the nominal molecular weight, based on the names under which the PEG compounds are sold.

### e) Types of Detergent Composition

The detergent composition in the pouch may take the form of a ‘complete detergent’ such as a laundry detergent or dishwashing detergent. Alternatively it may take the form of a separate detergent additive, such as a detergent booster or a bleach booster, which is intended to be used in conjunction with ‘complete detergent’ to improve the performance thereof.

The detergent composition may be a laundry detergent, a hard surface detergent such as a surface care or a dishwashing (especially automatic dishwashing) detergent. Laundry detergents include water softening compositions, main wash detergent compositions, detergent booster compositions, stain removal compositions and fabric treatment compositions such as fabric softening compositions. Dishwashing compositions include automatic dishwashing compositions, rinse aid compositions, machine cleaning compositions and detergent booster compositions. The detergent composition may also be a disinfectant, antibacterial or antiseptic composition, or a refill composition for a trigger-type spray.

The compositions of the invention are preferably provided as products having a mass of from 5 to 100 g, especially from 10 to 50 g, more preferably 15 to 35 g.

The detergent pouch of the present invention provides for the possibility of sequential release. For example, the liquid phase may be released into the wash liquor first from the outer pouch and the solid phase may be released into the wash liquor thereafter. If the solid phase has a coating or its own water soluble or water dispersible pouch the release of this phase into the surrounding wash liquor may be controlled to occur at a specific time in the wash cycle.

### e) Production of the Overall Product

The overall pouch product of the invention may be assembled in any suitable manner. One preferred method comprises the steps of;
producing a solid phase of a detergent composition, preferably a solid shaped body, most preferably a detergent tablet,
optionally applying a coating onto at least a part of the solid phase, or, placing the solid phase inside its own water soluble or water dispersible pouch and sealing said pouch,
producing a liquid phase of a detergent composition,
producing an open outer flexible water soluble or water dispersible pouch, preferably by vacuum forming, thermoforming or a Form Fill Seal process,
placing the solid phase (in coated or uncoated form or inside its own pouch as above) into the open outer flexible water soluble or water dispersible pouch,
introducing the required amount of the liquid phase of the detergent composition into the open outer flexible water soluble or water dispersible pouch, and
sealing the open outer flexible water soluble or water dispersible pouch.

Any suitable method may be used to seal the open outer flexible water soluble or water dispersible pouch in any method used to produce it such as heat sealing, laser sealing and ultrasonic sealing.

### f) Washing Processes

The pouches of the invention are typically used in laundry washing machines and dishwashing machines. The pouches can be added to the dispensing draw of the laundry washing machines but they are more usually added directly to the drum of the machine. In dishwashers the pouches are typically added to the dispensing draw.

An example of a pouch in accordance with the present invention will now be described with reference to the accompanying drawings, in which:

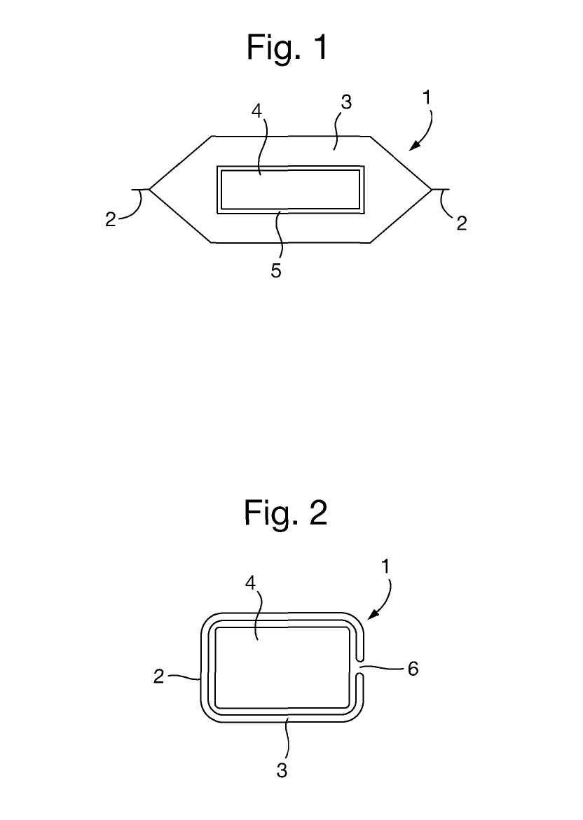

FIG. 1 is a schematic cross-section through the pouch, the pouch being of the unvented type.

FIG. 2 is a schematic cross-section through the pouch, the pouch being of the vented type.

The pouch comprises a flexible outer pouch (1) formed from a water soluble or water disersible material. In figure It is sealed at positions (2) and along the transverse length of the pouch. The pouch is filled with a liquid phase (3) of a detergent composition and a solid tablet (4) of a detergent composition.

In FIG. 1 the tablet has its own water soluble or water dispersible pouch (5).

In FIG. 2 the tablet is shown without a coating or its own pouch. However it may equally be produced with a coating or its own pouch. The venting system (6) is a channel running from the interior of the external pouch (1) to the atmosphere.

The present invention thus also provides in a second aspect a method of washing items to be cleaned, the method comprising the step of contacting the water soluble or water dispersible pouch of the first aspect of the invention with water in the presence of items to be cleaned. Preferably this method is carried out in an automatic washing machine such as a dishwashing machine or a laundry washing machine.

The items to be cleaned are preferably laundry items or dishware.

It will be understood that the features of the first aspect of the invention shall apply mutatis mutandis to the second aspect of the present invention.

The invention will now be further described by way of the following non-limiting examples. Further embodiments within the scope of the invention will be apparent to the person skilled in the art.

### EXAMPLES

A detergent pouch according to the present invention was produced according to the following formulation. A detergent tablet was produced by compression of a powder of to produce a compacted detergent tablet having the formulation given in table 1.

The tablet weight was 21.2 g. The liquid composition weight was 3.5 g. The total product when dissolved had a pH (1% by weight solution in water) at 20° C. of 10.3.

### Example 1

| | % wt based on the wt of |
|---|---|
| | tablet + liquid phase |
| Tablet formulation (solid phase) | |
| Sodium Percarbonate | 10.5 |
| Sodium tripolyphosphate | 38.0 |
| Sodium carbonate | 16.9 |
| Sodium bicarbonate | 3.0 |
| Polyethylenglycol 1500 | 3.0 |
| Polyethylenglycol 6000 | 2.6 |
| TAED | 3.1 |
| HEDP | 0.2 |
| C₁₆-C₁₈ Fattyalcohol Ethoxylate | 1.9 |
| Amylase | 0.6 |
| Protease | 1.3 |
| Sulfonated co-polymer (AA: AMPS) | 5.0 |
| Liquid phase; | |
| statistical EO-PO polymer 4:1 ratio, | 3.5 |
| MW 20,000 g/mol (available as P41/12000 | |
| ex Clariant) | |
| Total weight of tablet and liquid phase | 100.0 |

### Pouch Preparation:

Two pieces of a 14 cm×7 cm piece of PVOH film (thickness 90 mm) were are sealed along three sides to form an open pouch. The open pouch was then filled with the tablet of Table 1 followed by 3.5 g of the statistical EO-PO polymer. The open side of the pouch was sealed once the liquid phase had been added with as much air as possible being removed from the pouch in the process. However a small amount of air (approximately 0.5-1 ml remained in the pouch).

The total weight of the pouch was 26.2 g; 1.5 g PVOH film, 21.2 g compressed detergent tablet and 3.5 g of the liquid phase. The liquid phase surrounds the tablet on all sides and the tablet is thus suspended in the liquid phase inside the closed pouch.

The prepared pouches containing the solid detergent tablet phase suspended in the liquid phase were stored as below;

### Stability Results:

The pouch of Example 1 was stored in doy-pack packaging for 1 week at 50° C. to assess the stability of the percarbonate bleach upon storage.

TABLE 2

| Ingredient | Start Value | After 1 Week @50° C. |
|---|---|---|
| Percarbonate - | 100% | 93% |
| Active Oxygen | | |
| TAED | 100% | 90% |

The results show that there is little loss of available bleaching activity on storage. Also the appearance of the pouch is substantially unchanged; the pouch did not swell from oxygen release by the percarbonate. Also the tablet did not break or dissolve in the liquid phase and pouch did not show leakage of the liquid phase or discolouration.

1. A detergent pouch product comprising:
a flexible outer pouch; and
a detergent composition contained in the pouch;
wherein the detergent composition comprises at least one phase in solid form and at least one liquid phase; and
wherein at least one phase in solid form is predominantly surrounded by a liquid phase.

2. The pouch product according to claim 1, wherein at least one phase in solid form is a detergent tablet.

3. The pouch product according to claim 1, wherein at least one phase in solid form has a covering.

4. The pouch product according to claim 1, wherein the volume ratio of the total phases in solid form to the total liquid phases is in the range of from 10:1 to 1:5.

5. The pouch product according to claim 1, wherein at least one phase in solid form is fully surrounded by a liquid phase.

6. The pouch product according to claim 1, wherein a liquid phase comprises a surfactant.

7. The pouch product according to claim 6, wherein the surfactant is selected from the group consisting of a cationic surfactant, an anionic surfactant, a nonionic surfactant, and a combination of one or more such surfactants.

8. The pouch product according to claim 6, wherein the surfactant comprises a C12-15-(6-10)-EO-(3-5)PO nonionic surfactant.

9. The pouch product according to claim 1, wherein a liquid phase comprises a polymer.

10. The pouch product according to claim 9, wherein the polymer comprises random, branched ethylene oxide/propylene oxide copolymers having a molar ratio of EO:PO units in the range of from 10:1 to 1:1.

11. The pouch product according to claim 1, wherein the pouch has a vent extending from the interior of the pouch to the outside of the pouch.

12. (canceled)

13. A detergent pouch product comprising:
a flexible water soluble or water dispersible outer pouch; and
a detergent composition contained in the pouch;
wherein the detergent composition comprises at least one solid phase and at least one liquid phase; and
wherein at least one solid phase is predominantly surrounded by a liquid phase.

14. The pouch product according to claim 13, wherein the pouch is formed by a film having a thickness of between 40 μm to 150 μm.

15. The pouch product according to claim 13 further comprising a venting system communicating the interior of the pouch to outside of the pouch.

16. The pouch product according to claim 13, wherein the total liquid phase is in direct contact with at least 80% of the inner surface area of the outer pouch.

17. The pouch product according to claim 13, wherein a liquid phase comprises a C12-15-(6-10)-EO-(3-5)PO nonionic surfactant.

18. The pouch product according to claim 13, wherein a liquid phase comprises random, branched ethylene oxide/propylene oxide copolymers having a molar ratio of EO:PO units in the range of from 10:1 to 1:1.

19. The pouch product according to claim 13, wherein the at least one solid phase and at least one liquid phase comprise the following constituents in the following % wt:

| | % wt based on the wt of |
|---|---|
| | tablet + liquid phase |
| Tablet formulation (solid phase) | |
| Sodium Percarbonate | 10.5 |
| Sodium tripolyphosphate | 38.0 |
| Sodium carbonate | 16.9 |
| Sodium bicarbonate | 3.0 |
| Polyethylenglycol 1500 | 3.0 |
| Polyethylenglycol 6000 | 2.6 |
| TAED | 3.1 |
| HEDP | 0.2 |
| C₁₆-C₁₈ Fattyalcohol Ethoxylate | 1.9 |
| Amylase | 0.6 |
| Protease | 1.3 |
| Sulfonated co-polymer (AA: AMPS) | 5.0 |
| Liquid phase; | |
| statistical EO-PO polymer 4:1 ratio, | 3.5 |
| MW 20,000 g/mol (available as P41/12000 | |
| ex Clariant) | |
| Total weight of tablet and liquid phase | 100.0 |

20. A method of washing items to be cleaned comprising contacting the detergent pouch of claim 13 with water in the presence of items to be cleaned.

21. A method of washing items to be cleaned comprising contacting the detergent pouch of claim 19 with water in the presence of items to be cleaned.
